(19) United States
(12) Patent Application Publication
(10) Pub. No.: US 2011/0247121 A1
(43) Pub. Date: Oct. 13, 2011

(54) Products with Attachments that Alter Appearance or Enhance Functionality

(76) Inventor: Gregory Scott Cart, St. Augustine, FL (US)

(21) Appl. No.: 13/085,145

(22) Filed: Apr. 12, 2011

Related U.S. Application Data
(60) Provisional application No. 61/342,342, filed on Apr. 12, 2010.

(51) Int. Cl. A41D 13/00; B32B 3/06; A41D 27/10; A41D 27/20; F41H 3/00; A41D 27/08

(52) U.S. Cl. 2/69; 428/99

(57) ABSTRACT

Garments and other products are provided with a surface area and an attachment configured to releasably attach thereto and change its overall appearance. The surface area may have a camouflage pattern depicting a first natural environment while the attachment may have a camouflage pattern depicting a different natural environment. The attachment can introduce new or different natural elements, for example, adding a leaf, branch, or bark of a particular type of tree not depicted by the surface area to achieve various benefits, for example, making a camouflage product suitable for use in a different hunting environment. A portion of the surface area may comprises exposed attachment elements to allow the attachment to attach in any location and any orientation overlapping a sub-portion of the portion of the surface area. The portion of the surface area allowing such attachment can be the entirety of the outside and/or inside of a garment.

### RELATED APPLICATION

This document claims the benefit of U.S. Provisional Application Ser. No. 61,342,342, entitled “GARMENTS WITH APPEARANCE CHANGING ATTACHMENTS AND HANGING PANELS” and filed Apr. 12, 2010, the entire contents of which are incorporated by this reference.

### FIELD

Embodiments of this invention generally relate to camouflage and other patterns incorporated on or otherwise used with garments and other products.

### BACKGROUND

Various types of camouflage and other garments are used by hunters, military persons, and other users. Such users often own and use multiple garments to address different needs. For example, a hunter may have one or more camouflage garments for hunting for different types of game, one or more camouflage garments for hunting in different parts of the country, one or more hunting garments for complying with various states' Hunter Orange safety requirements, etc. Having to purchase, store, and travel with such multiple garments can be burdensome on hunters and other garment users.

### SUMMARY

One embodiment provides a garment that comprising a base garment comprising a surface area comprising a camouflage pattern depicting a first natural environment and an attachment configured to releasably attach to the base garment to overlay a portion of the surface area to change an overall appearance of the garment, wherein the attachment comprises a second camouflage pattern depicting a second natural environment different from the first natural environment. One or both of the attachment and base garments can depict particular natural elements, such as leaves, bark, or branches of a particular type of tree. The attachment can alternatively or additionally introduce new or different natural elements, for example, adding a leaf, branch, or bark of a particular type of tree not depicted by the base garment. Such additional elements can change the overall appearance of the garment to achieve various benefits. In one exemplary embodiment, the additional elements provided by the attachment make the garment suitable as camouflage in an environment in which the base garment alone would not have served as suitable camouflage. In another exemplary embodiment, the garment is reversible and comprises a solid black inside pattern. In another exemplary embodiment, the camouflage pattern of the base garment and/or attachment comprises three dimensional elements such as real or fake foliage that projects from a camouflage image on the attachment. An attachment can alternatively or additionally comprise a scent producing element.

Another exemplary embodiment is a garment that comprises a base garment comprising a surface area and an attachment configured to releasably attach to the surface area of the base garment to overlay a portion of the surface area to change the appearance of the garment during use of the garment. A portion of the surface area of the base garment comprises exposed attachment elements to allow the attachment to attach in any location and any orientation overlapping a sub-portion of the portion of the surface area. The portion of the surface area of the base garment can be the entirety of an outside of the base garment. The portion of the surface area of the base garment can comprise some or all of the inside of the base garment. In one exemplary embodiment, the outside of the base garment depicts a different pattern than the inside of the base garment and the attachment can attach to either the inside or the outside. The attachment can also be reversible and the attachment may or may not depict different patterns on each of its reversible sides. An attachment may provide various functions in addition to changing the appearance of a garment or other product. For example, an attachment may provide a pocket or sleeve on a garment or other product. The attachment may provide a barrier to air, liquid, and/or insects.

A garment can be provided with one or more exposed attachment elements for attaching one or more attachments. Exemplary exposed attachment elements include, but are not limited to, zipper components, button components, fiber loops, and adhesives. The exposed attachment elements and attachments may be configured such that a first portion of the attachment can attach to the attachment elements of the base garment such that a second portion of the attachment hangs down to cover some of the garment's surface area. In one exemplary embodiment, the exposed attachment elements comprise fiber loops that interact with projections on an attachment to removably attach the attachment to the base garment.

Inventive concepts disclosed herein are not limited to use in the context of garments. Another exemplary embodiment comprises a product comprising a surface area and an attachment configured to releasably attach to the surface area to overlay a portion of the surface area to change the appearance of the product. A portion of the surface area comprises exposed attachment elements to allow the attachment to attach in any location and any orientation overlapping a sub-portion of the portion of the surface area. The surface area may comprise a camouflage pattern depicting a first natural environment and the attachment may comprises a second camouflage pattern depicting a second natural environment different from the first natural environment. Exemplary products include, but are not limited to, shirts, vests, and other garments, and ground blinds, guns, tents, backpacks, carry packs, linings, gun slings, bow slings, utility belts, tackle boxes, fishing holders, mats, parachutes, shoes, sandals, boots, watches and other hunting, military, and sporting products, as well as seating, upholstery, and internal and external surfaces of automobiles, trains, aircraft, boats, and other vehicles and within buildings.

Attachments can be used to change the appearance and/or supplement or otherwise enhance the functionality of such products. Exemplary supplemental functions include, but are not limited to, carrying capabilities provided by pockets, loops, and holsters, as well as comfort and safety capabilities provided by knee pads, padding, armor, bullet-proof substances, and water-proof substances. Attachments that provide these and other functions can be attached at various locations on a garment or other product such that a user can customize their use of the experience. For example, a right-handed user may position a holster on one side of a garment while a left-handed user may position the same holster attachment on the opposite side of the garment. Attachments may also be attached at customized positions based on differences of user body size and shape, the intended purpose of the product, personal preferences, and a variety of other reasons.

The terms “invention,” “the invention,” “this invention” and “the present invention” used in this patent are intended to refer broadly to all of the subject matter of this patent and the patent claims below. Statements containing these terms should not be understood to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to the entire specification of this patent, all drawings and each claim. The terms “panel” and “attachment” are used interchangeably herein.

### BRIEF DESCRIPTION OF THE DRAWINGS

Illustrative embodiments of the present invention are described in detail below with reference to the following drawing figures.

FIG. 1 illustrates a garment having a base and various attachments.

FIG. 2 illustrates another exemplary garment to which a panel attachment has been attached to add Hunter Orange to the garment.

FIG. 3 illustrates another exemplary garment having a base and various attachments.

FIGS. 4A-C illustrate a ground blind and various attachments for use with the ground blind.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

Various improved garments are disclosed. An exemplary garment is provided by providing a base garment and an attachment that can be attached to the base garment to change its appearance. By changing a portion of the garment, the appearance of the entire garment can be changed sufficiently to achieve a desired appearance. For example, if the base garment has a foliage-based camouflage pattern that is appropriate for a particular region of the country, an attachment that adds larger trees may change the overall appearance of the garment to make is suitable for use in another region of the country.

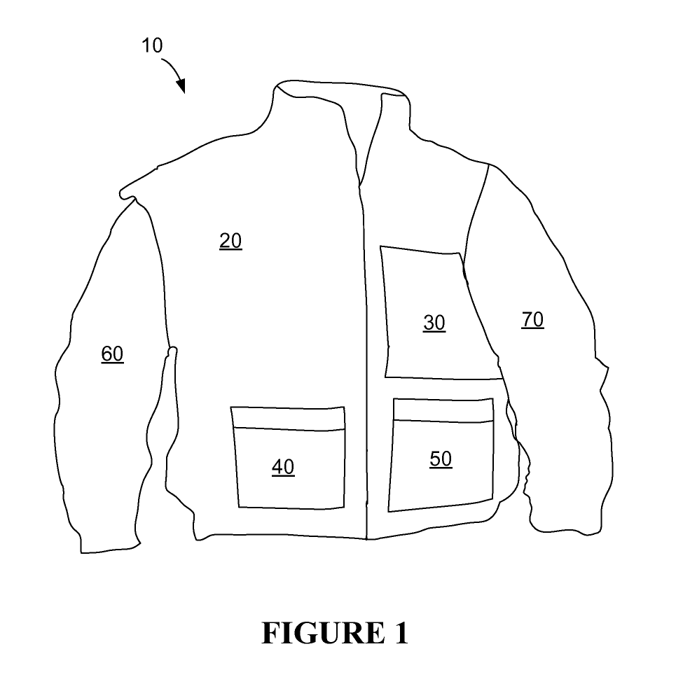

FIG. 1 illustrates a garment 10 having a base 20 and various attachments 30, 40, 50, 60, 70. The size and positions of these attachments are merely illustrative. Alternative sizes and positions may be appropriate depending on the intended use or uses of the garment. In FIG. 1 the garment may be worn without any of the attachments 30, 40, 50, 60, 70 so that only the pattern of the base 20 is visible on the garment. However, this appearance can be changed by attaching one or more of attachments 30, 40, 50, 60, 70. For example, panel attachment 30 may be attached to add a different pattern to the portion of the base overlaid by the panel attachment 30 after it is attached. Similarly, pocket attachments 40, 50 may be attached to change the appearance of the respective portions of the base 20 overlain by those attachments 40, 50. Arm attachments 60, 70 may be attached to a base garment that may or may not already have sleeves. In the case of a garment base 30 that already has sleeves, the arm attachments 60, 70 will overlay all or part of those sleeves to change the appearance of the overall garment. In the case of a base garment without sleeves, the arm attachments 60, 70 may be added both to add sleeves and to change the appearance of the overall garment.

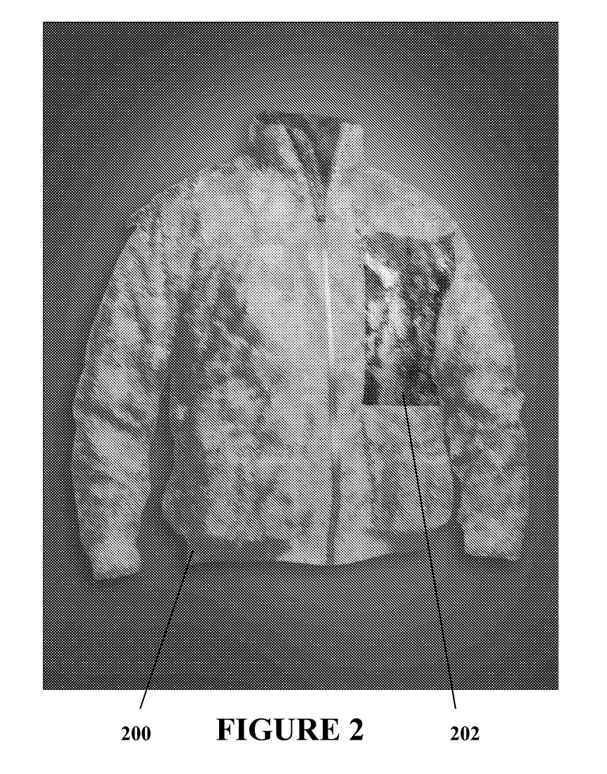

FIG. 2 illustrates another exemplary garment 200 to which a panel attachment 202 has been attached to add Hunter Orange to the garment 200. In alternative embodiments, such panels may be positioned on other portions of a garment 200 and/or upon multiple portions of the garment 200 to achieve a required amount of Hunter Orange. Such panels may or may not allow some of the underlying pattern to show through. Panels and other attachments may be configured to provide barriers to air, liquid, insects, and any other substance for which such a barrier is desired or may be configured to allow air, liquids, insects, and other substances to pass through as may be desired for particular circumstances.

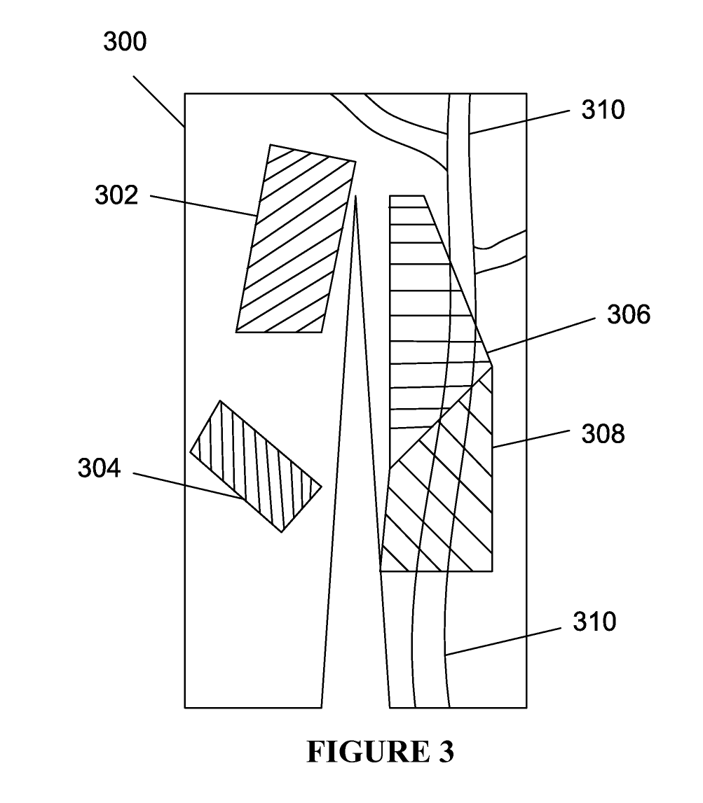

FIG. 3 illustrates another exemplary garment 300 having various attachments 302, 304, 306, and 308. In this exemplary garment 300 attachment 306 has been attached adjacent to attachment 308. The garment appearance includes a branch 310. Attachment 306 and attachment 308 are attached in positions such that the pattern of attachment 306 displays a portion of the branch 310 that aligns with another portion of branch 310 on the garment 300 base and attachment 308 displays yet another portion of the branch 310 that aligns with another portion of branch 310 on the garment 300 base as well as the portion of the branch on attachment 306. Such alignment can facilitate continuity or other appearance characteristics of a garment or other product. Attachments can be used to change the appearance of a garment or other product without detracting from certain camouflage or other aesthetic characteristics of the garment.

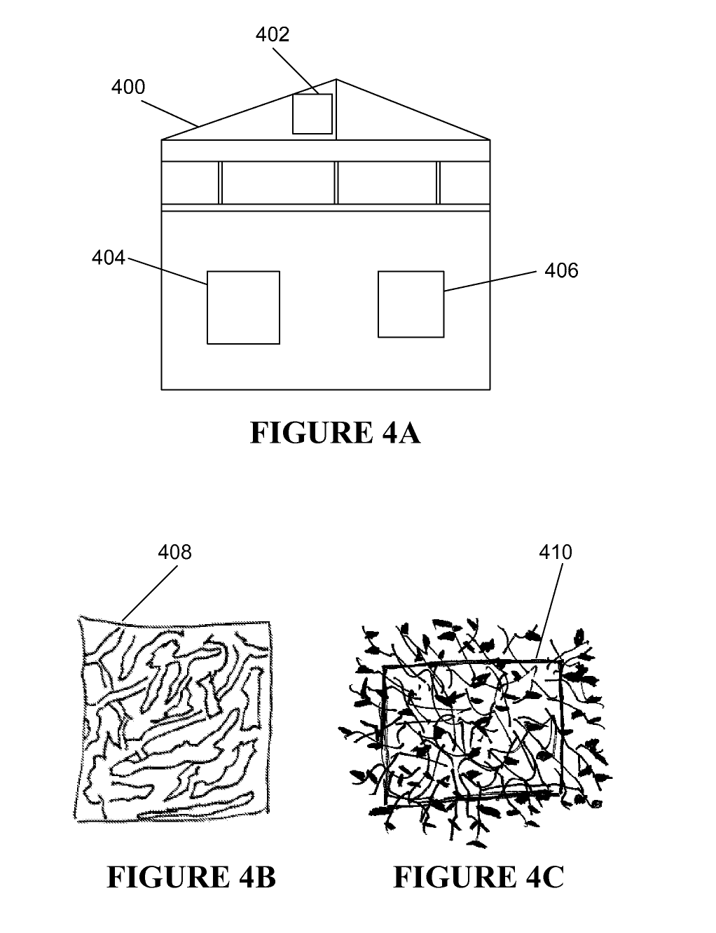

FIG. 4A-C illustrate a ground blind 400 and various attachments 408 and 410 for use with the ground blind, for example, by attaching one or more of the attachments at attachment locations 402, 404, and 406. Such attachments 408 and 410 may attach to specific attachment components on the ground blind or may attach more generally to at various locations and/or in various locations by attaching directly to the fabric or other material from which all or a portion of the ground blind outer surface is made.

The locations and sizes of attachments for use on a garment may be determined for the particular purposes intended for the garment. Alternative configurations may be tested to confirm that the garment looks and/or functions as desired for such intended purposes. In certain embodiments, an attachment's pattern or other appearance attribute is configured to align or otherwise match with the appearance of the adjacent base pattern or other attachments. For example, an attachment may have a tree branch that extends to an edge of the attachment and, when the attachment is attached to a particular garment, the base portion of the garment may have another portion of the same branch that aligns with the attachments portion. Such alignment provides one example of pattern elements that can facilitate an integrated appearance in the garment that can improve the look and function of the garment.

In some embodiments, attachments will have both elements common to a base garment (e.g., pine tree features) and elements that are not present in the base garment (e.g., maple tree features). The use of such common elements and uncommon elements can facilitate the use of attachments that alter the overall appearance of the garment without looking out of place or otherwise detracting from the appearance or function of the garment.

In certain exemplary embodiments, a camouflage garment is provided by providing a base garment having an general purpose camouflage pattern and one or more attachments that can be attached to make the garment suitable for particular purposes. A hunter can purchase and use such a garment as an alternative to purchasing multiple individual garments. Since only a single garment may be purchases, a hunter may be willing to spend more money on the garment, for example, by purchasing a garment of a higher quality materials or that is otherwise better or improved.

In certain exemplary embodiments, a base garment is provided that is reversible. For example, a base garment may have a general purpose camouflage pattern on the outside and a solid black pattern on the inside, for example, for use inside a ground blind. The black pattern can be used by turning the garment inside out. Such a reversible garment may have mechanisms for attaching attachments on one or both of the outside and inside of the garment.

Garment attachments may also be reversible. For example, panel attachment 30 shown in FIG. 1 may have a first pattern on its front side and a second different pattern on the opposite side. The attachment may use a single attachment mechanism, such as a zipper, for attaching the attachment with either of the front side or opposite side facing outward.

Garment attachments may be configured to attach to a base garment in a variety of alternative ways. In certain embodiments, a zipper portion on a garment attachment interacts with a zipper portion on the base garment to attach one or more ends of the attachment to the base garment. In one exemplary embodiment, an attachment is attached by only its top end so that the attachment hangs from that end to cover a portion of the base garment. In anther exemplary embodiment, an attachment connects to the garment on two opposing ends (e.g., on both its top end and its bottom end). In another exemplary embodiment, an attachment connects to a base garment along the attachment's entire periphery. For example, a circular shaped attachment may have a zipper that attaches the attachment along its entire circumference. Other configurations are possible.

In addition to using a zipper to connect an attachment, an attachment can be attached by alternative mechanisms. For example, Velcro-type portions can be used to attach an attachment around its edges or elsewhere on a side of the attachment. Alternatively, one or more buttons could be used to attach an attachment. As yet another alternative, various types of adhesive could also be used to facilitate attachment. In general, a garment can be configured so that the mechanism used to attach the attachment is concealed. For example, the zippers used to attach an attachment may be concealed by one or more small flaps on the base garment or attachment itself. Such flaps or other features may also provide weather protection and/or other functions.

In an alternative embodiment, a panel that is used to change the appearance of a base garment is part of the base garment itself. For example, a garment may provide a pocket from which a partially attached panel can be extended. For example, a user may open the pocket and pull the panel out so that the panel hangs down on the outside of the garment from its attachment at the pocket and covers a portion of the garment to change its appearance. As another example, a neck pouch of a jacket or shirt garment may conceal a hanging panel that, when extended, hangs down to cover some or all of the back of the garment. Such hanging panels may be used as an alternative to or in addition to one or more attachments described herein. A button or other attachment mechanism may be provided to secure such a hanging panel in its out position. As a specific example, the bottom of a hanging panel may be secured to the outside of the garment using a button.

The pattern on either a base garment, attachments, or hanging panels can be two dimensional or three dimensional or a combination of the two. For example, an attachment panel may include real or fake foliage that projects from the panel having a camouflage image on its primary surface.

Base garments, attachments, or hanging panels can be configured to provide various complementary features. For example, an attachment may both change the appearance of the base garment to which it attaches and add functionality. The pocket-type attachments described above are one example. Another example involves attachments or hanging panels that are provided to add or control scent, e.g., to provide a pine scent, etc. As another example, attachments or hanging panels may be provided to provide a portion or all of a carry system, e.g., providing a carry system for carrying a big turkey, etc.

The attachment and panel features described herein are generally applicable to a variety of different garments including, but not limited to, shirts, jackets, vests, bibs, pants, one-piece suits, hats, socks, and other types of apparel.

The base garments, attachments, or hanging panels described herein can be used in the context of camouflage and other garment patterns. In certain embodiments, a garment attachment is used to change the appearance of a garment for fashion reasons. For example, an attachment may be provided to add a stripe to a garment or to add a particular trademark, logo, military identification, or other designation to a garment. For example, a group may select a particular attachment for group members to attach so that group members are visually distinct from non-group members. As a specific example, a class of children on a field trip may all zip on a bright yellow attachment member to facilitate identification of children in the class.

Generally, the base garments, attachments, or hanging panels can be used to facilitate reuse of a garment after (or in circumstances in which) the base appearance of the garment is not desirable. Such interchangeability may facilitate reuse of a particular garments base even after the appearance of the base garment is no longer fashionable or desirable.

The embodiments described above are illustrative and non-limiting. Many variations of the structures illustrated in the drawings and the materials described are possible and within the scope of this invention. Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

1. A garment comprising:
a base garment comprising a surface area comprising a camouflage pattern depicting a first natural environment; and
an attachment configured to releasably attach to the base garment to overlay a portion of the surface area to change an overall appearance of the garment, wherein the attachment comprises a second camouflage pattern depicting a second natural environment different from the first natural environment.

2. The garment of claim 1 wherein both the attachment and the base garment depict a particular natural element.

3. The garment of claim 2 wherein the particular natural element comprises a leaf, branch, or bark of a particular type of tree.

4. The garment of claim 1 wherein the attachment, but not the garment, depicts a particular natural element.

5. The garment of claim 4 wherein the particular natural element comprises a leaf, branch, or bark of a particular type of tree.

6. The garment of claim 1 wherein the attachment depicts a first portion of a natural element and the base garment depicts a second portion of the natural element and wherein, when the attachment is attached to the base garment, the first portion of the natural element aligns with the second portion of the first natural element.

7. The garment of claim 1 wherein:
both the attachment and the base garment depict a first natural element, wherein the first natural element comprises a leaf, branch, or bark of a first particular type of tree;
the attachment, but not the garment, depicts a second type of natural element, wherein the second natural element comprises a leaf, branch, or bark of another particular type of tree different from the first particular type of tree; and
wherein the attachment depicts a first portion of a third natural element and the base garment depicts a second portion of the third natural element and wherein, when the attachment is attached to the base garment, the first portion of the third natural element aligns with the second portion of the third natural element.

8. The garment of claim 1 further comprising a second attachment configured to releasably attach to the base garment to overlay another portion of the surface area to change the overall appearance of the garment, wherein the attachment depicts a first portion of a natural element and the second attachment depicts a second portion of the natural element, wherein, when the attachment and second attachment are attached adjacent to one another on the base garment, the first portion of the natural element aligns with the second portion of the natural element.

9. The garment of claim 1 wherein the garment is reversible and comprises a solid black inside pattern.

10. The garment of claim 1 wherein the second camouflage pattern of the attachment comprises three dimensional elements comprising real or fake foliage that projects from a camouflage image on the attachment.

11. The garment of claim 1 wherein the attachment comprises a scent producing element.

12. A garment comprising:
a base garment comprising a surface area; and
an attachment configured to releasably attach to the surface area of the base garment to overlay a portion of the surface area to change the appearance of the garment during use of the garment,
wherein a portion of the surface area of the base garment comprises exposed attachment elements to allow the attachment to attach in any location and any orientation overlapping a sub-portion of the portion of the surface area.

13. The garment of claim 12 wherein the portion of the surface area of the base garment comprises an entirety of an outside of the base garment.

14. The garment of claim 13 wherein the portion of the surface area of the base garment further comprises at least some of the inside of the base garment.

15. The garment of claim 14 wherein the outside of the base garment depicts a different pattern than the inside of the base garment, wherein the attachment can attach to either the inside or the outside.

16. The garment of claim 12 wherein the attachment is reversible and depicts a different pattern on each reversible side.

17. The garment of claim 12 wherein the attachment attaches to provide a pocket on the garment.

18. The garment of claim 12 wherein the attachment attaches to provide sleeves on the garment.

19. The garment of claim 12 wherein, when attached, at least some of an underlying pattern of the sub-portion of the portion of the surface area overlapped by the attachment is visible through the attachment.

20. The garment of claim 12 wherein the attachment is a barrier to air, liquid, and insects.

21. The garment of claim 12 wherein the attachment permits the passage of air, liquid, and insects.

22. The garment of claim 12 wherein the exposed attachment elements comprise one or more of a zipper component, button component, fiber loops, and an adhesive.

23. The garment of claim 12 wherein the exposed attachment elements and attachment are configured such that a first portion of the attachment can attach to the attachment elements of the base garment such that a second portion of the attachment hangs down to cover the sub-portion.

24. The garment of claim 12 wherein the exposed attachment elements comprise fiber loops that interact with projections on the attachment to removably attach the attachment to the base garment.

25. The garment of claim 12 wherein the attachment is permanently attached to the base garment.

26. The garment of claim 25 wherein the garment base comprises a pocket or pouch from which the attachment can be extended to hang down from a point of permanent attachment and removably attach in an extended position to overlay the sub-portion.

27. The garment of claim 25 wherein, when detached from the base garment, the attachment comprises an enclosure for securing items.

28. A product comprising:
a surface area; and
an attachment configured to releasably attach to the surface area to overlay a portion of the surface area to change the appearance of the product,
wherein a portion of the surface area comprises exposed attachment elements to allow the attachment to attach in any location and any orientation overlapping a sub-portion of the portion of the surface area.

29. The product of claim 28 wherein:
the surface area comprises a camouflage pattern depicting a first natural environment; and
the attachment comprises a second camouflage pattern depicting a second natural environment different from the first natural environment.

30. The product of claim 29 wherein the product is a ground blind or a gun.

31. The product of claim 28 wherein attachment of the attachment as part of the product enhances carrying capability of the product.

32. The product of claim 28 wherein attachment of the attachment as part of the product provides padding on the product.

33. The product of claim 28 wherein attachment of the attachment as part of the product enhances bullet-protection capabilities of the product.
